(19) United States
(12) Patent Application Publication
(10) Pub. No.: US 2005/0253480 A1
(43) Pub. Date: Nov. 17, 2005

(54) Apparatus and method for reducing shaft charge

(76) Inventor: William P. Pizzichil, Easley, SC (US)

Correspondence Address: ROCKWELL AUTOMATION, INC./(FY), ATTENTION: SUSAN M. DONAHUE, 1201 SOUTH SECOND STREET, MILWAUKEE, WI, 53204, US

(21) Appl. No.: 10/845,952

(22) Filed: May 14, 2004

(51) Int. Cl. H02K 1/22

(52) U.S. Cl. 310/261

(57) ABSTRACT

According to an exemplary embodiment, the present invention provides a rotatable element, such as a rotor for an electric motor. The exemplary rotatable element has a core with a generally circular cross-section and a channel that extends through the core along an axial centerline of the core. The element also includes a shaft that is secured to the core and that is disposed in the channel. Additionally, the element includes a dielectric layer disposed between the shaft and the core that electrically insulates the core and shaft with respect to one another. Accordingly, the dielectric layer prevents current from flowing between the core and the shaft. In turn, the dielectric layer reduces the development of charge in the shaft.

### BACKGROUND

The present invention relates generally to electromechanical systems, such as an electric motor. Although the following discussion focuses on electric motors, the present invention affords benefits to a number of electromechanical systems and devices that have rotatable elements.

Electric motors of various types are commonly found in industrial, commercial and consumer settings. In industry, such motors are employed to drive various kinds of machinery, such as pumps, conveyors, compressors, fans and so forth, to mention only a few. Such motors generally include a stator, comprising a multiplicity of coils, surrounding a rotor, which is supported by ball bearings for rotation in the motor housing. When power is applied to the motor, an electromagnetic relationship between the stator and the rotor causes the rotor to rotate. Typically, a rotor shaft extending through the motor housing takes advantage of this produced rotation and translates the rotor's movement into a driving force for a given piece of machinery. That is, rotation of the rotor shaft drives the machine to which it is coupled.

Virtually all rotatable motors, generators, etc., develop some degree of rotor shaft-to-ground voltage (V_{rg}) that can result in bearing currents (I_{b}). Typically, electric motors have two sources of V_{rg}: electromagnetic induction and electrostatic coupling. Electromagnetic induction generally results from the electromagnetic relationships between the stator and the rotor. For example, small dissymmetries of the magnetic field in the air gap between the rotor and the stator due to motor construction can cause electromagnetically induced V_{rg} to develop in the shaft. Electrostatic coupling, however, results from a number of situations in which rotor or shaft charge accumulation can occur. For example, ionized or high velocity air passing over a rotor may cause rotor charge accumulation, which, in turn, leads to a build-up of charge on the shaft. However, external sources to the motor generally give rise to the lion's share of V_{rg} due to electrostatic coupling. For example, modern voltage source inverters, such as pulse width modulated (PWM) inverters, produce stepped voltage waveforms and, as such, high dv/dt (change in voltage/change in time) values. Thus, PWM inverters lead to the development of V_{rg} levels in the shaft. In either case, the greater V_{rg} the greater the likelihood of bearing currents (I_{b}) and arcing within the bearing. That is, V_{rg} may cause a discharge of current through the bearing.

In traditional motors, the build-up of charge in the shaft is communicated to an inner race of the ball bearing assembly that supports the rotor. To reduce the coefficient of friction within the ball bearing assemblies, a lubricant typically coats the ball bearings located between the races of the bearing assemblies. However, the lubricant acts as a dielectric between the ball bearings and the respective races. Accordingly, the build-up of charge on the inner race of the bearing assembly causes parasitic capacitive coupling with respect to the ball bearings. If the voltage level in the rotor shaft and, as such, the inner race of the bearing assembly exceeds the lubricant's electric field breakdown, an instantaneous discharge of current or an arc between the inner race and the ball bearing can occur. That is, the greater V_{rg} in the shaft, the greater the likelihood of arcing or bearing currents (I_{b}) occurring.

Unfortunately, bearing currents (I_{b}) and/or arcing within the bearing can cause damage to mechanical components of the motor. For example, if V_{rg} reaches a sufficient threshold value, arcing occurs between the races of the bearing and the balls within the bearing, leading to electrical discharge machining (EDM) of the mechanical components of the bearing, for instance. That is, an instantaneous discharge of current (I_{b}) through the bearing causes an arc to occur, thereby causing EDM. EDM leads to pitting and fluting of the bearing components and may cause the bearing assembly to mechanically malfunction or to prematurely fail. Additionally, continued bearing current (I_{b}) produces heat that, over time, softens the bearing components, leading to premature mechanical degradation of the bearing, which ultimately can result in higher maintenance costs and downtimes.

Accordingly, there exists a need for methods and apparatus for reducing the development of shaft charge during operation of a motor.

### BRIEF DESCRIPTION

According to one embodiment, the present invention comprises a rotatable element, such as a rotor assembly for use with an electric motor. The rotatable element comprises a core having a generally circular cross-section and a channel extending along a centerline of the core, which is generally traverse to the circular cross-section. In the exemplary embodiment, the channel extends from a first end of the core to a second end of the core generally opposite the first end. The rotatable element also includes a shaft that is secured with respect to the core and that extends through the channel such that a portion of the shaft extends beyond at least one of the first and second ends of the core. Additionally, the rotatable element includes a dielectric layer disposed between the shaft and the core to electrically insulate the core and the shaft with respect to one another. Advantageously, the dielectric layer reduces the build-up of charge in the shaft due to parasitic capacitive coupling between the stator and rotor of a motor, for example.

According to another embodiment, the present invention provides an electric motor. The electric motor comprises a rotor and stator that are housed within a motor enclosure. The exemplary stator has a stator channel that extends from a first end of the stator to a second end of the stator generally opposite the first end. Additionally, the electric motor includes a rotor disposed within the stator channel. The rotor assembly includes a core and a shaft that extends axially through the core from an end of the rotor to the second opposite end such that the shaft extends beyond at least one of the first and second ends. A dielectric layer disposed between the core and the shaft electrically insulates the core and shaft with respect to one another. Accordingly, the dielectric layer facilitates a reduction in a build-up of charge developed in the shaft during operation of the motor. Thus, the likelihood of damage due to arcing, EDM, and bearing currents (I_{b}) may be mitigated in the bearing assembly.

According to yet another embodiment, the present invention provides a method for manufacturing a rotor. The exemplary method includes forming a rotor core having a generally circular cross-section and a channel extending through the rotor core axially along a centerline of the rotor core, which is generally transverse to the rotor core cross-section. Additionally, the method includes the act of coating at least one of an outer surface of the rotor shaft and an inner surface of the rotor core defined by the channel with a dielectric material. Furthermore, the method includes the acts of inserting the rotor shaft and securing the rotor shaft with respect to the rotor core. Once assembled, the rotor may be inserted into a motor assembly for operation.

### DRAWINGS

The foregoing and other advantages and features of the invention will become apparent upon reading the following detailed description and upon reference to the drawings in which:

FIG. 1 is a perspective view of an electric motor having features in accordance with an embodiment of the present invention;

FIG. 2 is a partial cross-section view of the motor of FIG. 1. along line 2-2;

FIG. 3 is a detail view of a bearing assembly of the motor of FIG. 1 along line 3-3; and

FIG. 4 illustrates in block form an exemplary process for manufacturing a rotor, in accordance with an embodiment of the present invention.

### DETAILED DESCRIPTION

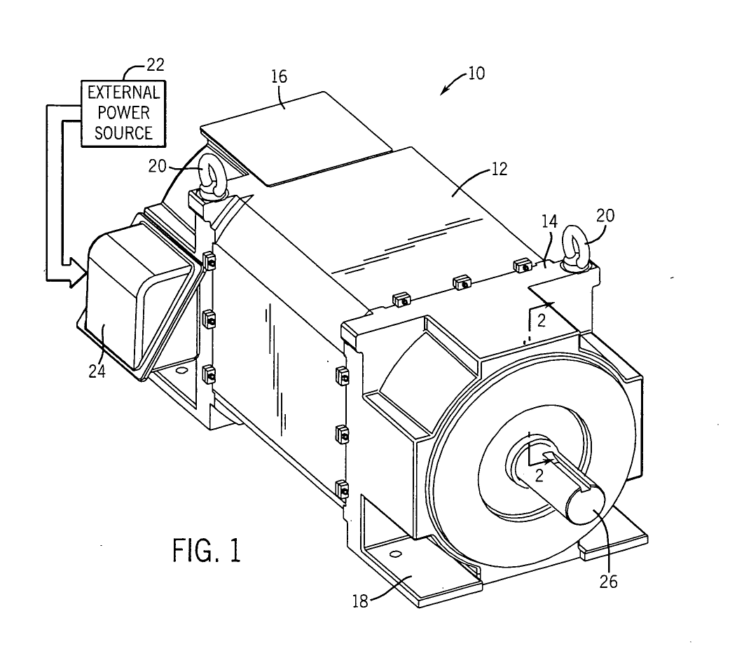

As discussed in detail below, embodiments of the present invention provide apparatus and methods for reducing the build-up of charge within rotatable members of electromechanical devices. Turning to the drawings, FIG. 1 illustrates an exemplary electric motor 10. In the embodiment illustrated, the motor 10 comprises an induction motor housed in a motor housing. The exemplary motor 10, particularly the motor housing, comprises a frame 12 capped at each end by front and rear endcaps 14 and 16, respectively. The frame 12 and the front and rear endcaps 14 and 16 cooperate to form a protective enclosure or motor housing for the motor 10. The frame 12 and the front and rear endcaps 14 and 16 may be formed of any number of materials, such as steel, aluminum, or any other suitable structural material. Advantageously, the endcaps 14 and 16 may include mounting and transportation features, such as the illustrated mounting flanges 18 and eyehooks 20. Those skilled in the art will appreciate in light of the following description that a wide variety of motor configurations and devices may employ the charge build-up-reducing techniques outlined below.

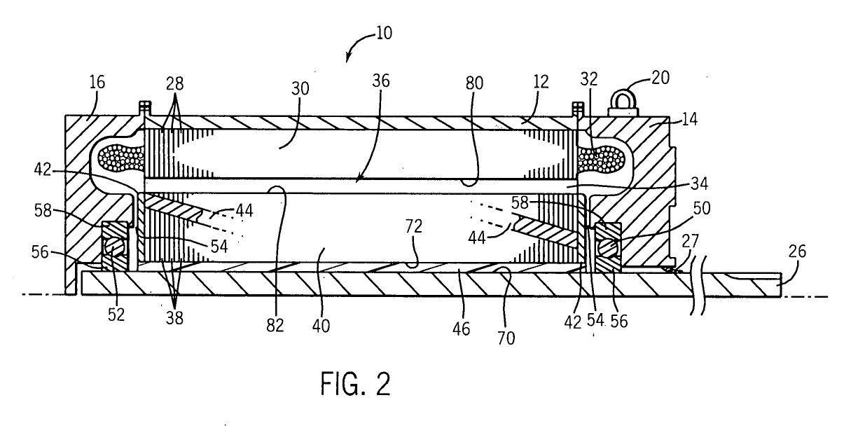

To induce rotation of the rotor assembly, current is routed through stator windings disposed in the stator. (See FIG. 2.) Stator windings are electrically interconnected to form groups, which are, in turn, interconnected in the manner generally known in the pertinent art. The stator windings are further coupled to terminal leads (not shown), which electrically connect the stator windings to an external power source 22, such as 480 Vac three-phase power or 110 Vac single-phase power. As another example, the external power source 22 may comprise an ac pulse width modulated (PWM) inverter. A conduit box 24 houses the electrical connection between the terminal leads and the external power source 22. The conduit box 24 comprises a metal or plastic material and, advantageously, provides access to certain electrical components of the motor 10. Routing electrical current from the external power source 22 through the stator windings produces a magnetic field that induces rotation of the rotor assembly. A rotor shaft 26 secured to the rotor core of the rotor assembly rotates in conjunction with the rotor assembly. That is, rotation of the rotor core translates into a corresponding rotation of the rotor shaft 26. To support and facilitate rotation of the rotor core and the rotor shaft (i.e., the rotor assembly), the exemplary motor 10 includes front and rear bearing sets carried within the front and rear endcaps 14 and 16, respectively. (See FIG. 2.) As appreciated by those of ordinary skill in the art, the rotor shaft 26 may couple to any number of drive machine elements, thereby transmitting torque to the given drive machine element. By way of example, machines such as pumps, compressors, fans, conveyors, and so forth, may harness the rotational motion of the rotor shaft 26 for operation.

FIG. 2 provides a partial cross-section view of the motor 10 of FIG. 1 along line 2-2. To simplify the discussion, only the top portion of the motor 10 is shown, as the structure of the motor 10 is essentially mirrored along its centerline. As discussed above, the frame 12 and the front and rear endcaps 14 and 16 cooperate to form an enclosure or motor housing for the motor 10. To prevent the ingress of contaminants, seal assemblies, such as the illustrated lip seals 27, may abut the motor shaft 26. Within the enclosure or motor housing, specifically within the confines of the frame 12, reside a plurality of stator laminations 28 juxtaposed and aligned with respect to one another to form a stator core 30. Moreover, the stator laminations 28 cooperate to form slots that extend the length of the stator core 30 and are configured to receive one or more turns of a stator winding 32, illustrated as coil ends in FIG. 2. Furthermore, each stator lamination 28 includes a central aperture which, when aligned with respect to one another, cooperate to form a contiguous rotor passageway 34 that extends through the stator core 30.

In the exemplary motor 10, a rotor assembly 36 resides within this rotor passageway 34. Similar to the stator core 30, the rotor assembly comprises a plurality of rotor laminations 38 aligned and adjacently placed with respect to one another. Thus, the rotor laminations 38 cooperate to form a contiguous rotor core 40. The exemplary rotor assembly 36 also includes rotor end rings 42, disposed on each end of the rotor core 40, that cooperate to secure the rotor laminations 38 with respect to one another. When assembled, the rotor laminations 38 cooperate to form a channel that extends through the center of the rotor core 40. This channel is configured to receive the rotor shaft 26 therethrough. Once inserted, the rotor shaft 26 is secured with respect to the rotor core 40. That is, rotor core 40 and the rotor shaft 26 rotate as a single entity, the rotor assembly 36. The exemplary rotor assembly 36 also includes rotor conductor bars 44 that extend the length of the rotor core 40. As discussed further below, inducing a current in the rotor assembly 36, specifically in the conductor bars 44, causes the rotor assembly 36 to rotate. As also discussed further below, the rotor assembly 36 includes a dielectric layer 46 located between the rotor core 40 and the rotor shaft 26 that reduces the build-up of charge on the rotor shaft 26 during operation. By harnessing the rotation of the rotor assembly 36 via the rotor shaft 26, a machine coupled to the rotor shaft 26, such as a pump or conveyor, may operate.

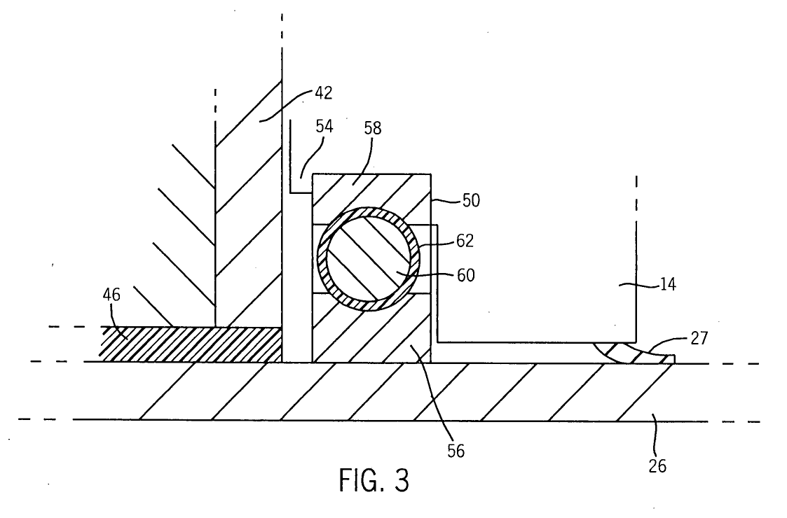

To support the rotor assembly 36, the exemplary motor 10 includes front and rear bearing sets 50 and 52, respectively, that are secured to the rotor shaft 26 and that facilitate rotation of the rotor assembly 36 within the stationary stator core 30. Advantageously, the end caps 14 and 16 include features, such as the illustrated lip portions 54, that secure the bearing sets 50 and 52 within the respective endcaps 14 and 16. During operation of the motor, the bearing sets 50 and 52 transfer the radial and thrust loads produced by the rotor assembly 36 to the motor housing. Each bearing set 50 and 52 includes an inner race 56 disposed circumferentially about the rotor shaft 26. The tight fit between the inner race 56 and the rotor shaft 26 causes the inner race 56 to rotate in conjunction with the rotor shaft 26. Each bearing set 50 and 52 also includes an outer race 58 and ball bearings 60 disposed between the inner and outer races. The ball bearings 60 facilitate rotation of the inner races 56 while the outer races 58 remain stationarily mounted with respect to the endcaps 14 and 16. Thus, the bearing sets 50 and 52 facilitate rotation of the rotor shaft 26 and the rotor assembly 36 while supporting the rotor assembly 36 within the motor housing, i.e., the frame 12 and the endcaps 14 and 16. In the exemplary motor 10, each of the ball bearings 60 is coated with a lubricant 62 (see FIG. 3), which reduces the coefficient of friction between the ball bearings 60 and the races 56 and 58. However, as discussed further below, the lubricant 62 acts as a dielectric and produces parasitic capacitive coupling within the bearing assemblies. By way of example, if sufficient charge is developed on the inner race 56 (from communicated shaft charge), the electrical field threshold of the lubricant 62 may be overcome and, as such, result in bearing currents (I_{b}) and/or EDM.

The dielectric layer 46 located between the rotor shaft 26 and the rotor core 40 reduces the development of shaft charge. For the purposes of explanation and illustration, the thickness of the dielectric layer 46 is exaggerated. The dielectric layer 46 is located between the outer perimeter 70 of the shaft and the inner perimeter 72 of the channel extending through the rotor core 40 along an axial centerline of the rotor core 40. In the exemplary embodiment, the dielectric layer 46 extends the length of rotor core 40 and, as such, electrically insulates the rotor core 40 with respect to the rotor shaft 26. That is, the dielectric layer 46 prevents current flow from the rotor core 40 into the rotor shaft 26, and vice versa. The dielectric layer 46 also extends between the rotor end rings 42 and the rotor shaft 26 to electrically insulate these items from one another as well. The dielectric layer 46, in the exemplary motor 10, is adhered to at least one of the rotor shaft 26 and the rotor core 40. Moreover, the tight fit between the rotor shaft 26 and the rotor core 40 (e.g., due to shrink-fitting) secures the rotor shaft 26 to the rotor core 40. Accordingly, the dielectric layer 46 does not substantially affect the integrity of the construction of the rotor assembly 36. The dielectric layer 46 may comprise a number of materials that prevent electrical communication between the rotor core 40 and the rotor shaft 26. For example, the dielectric layer may comprise a ceramic material, such as aluminum oxide. Moreover, to mitigate against the likelihood of disintegration of the dielectric layer 46 under operating stresses, the dielectric layer 46 may comprise a high yield-strength material, which is capable of sustaining the forces produced by shrink-fitting of the rotor core 40 onto the shaft 26, for instance.

During operation of the motor 10, a current passing through stator windings 32 electromagnetically induces a current in the conductor bars 44, thereby causing the rotor assembly 36 to rotate. In addition, the alternating current (e.g., PWM current) in the stator windings 32 causes a charge to build up on the inner surface 80 of the stator core 30. As charge builds on the inner surface 80 of the stator core 30, an electric field is produced. In turn, this electric field causes parasitic capacitive coupling between the inner surface 80 of the stator core 30 and the outer surface 82 of the rotor assembly 36. That is, the air gap between the rotor assembly 36 and the stator core 30 acts as a dielectric, while the inner surface 80 of the stator core 30 and the outer surface 82 of the rotor assembly 36 cooperate as plates of a capacitor, which accumulate charge. The capacitive coupling between the stator core 30 and the rotor assembly 36 also produces electrostatic effects within the rotor assembly 36 and the stator core 30 themselves. For example, when the charge on the inner surface 58 of the stator core 30 is negative, free electrons in the adjacent conductors (e.g., the rotor assembly 36) are repelled. Accordingly, electrons within the rotor core 40 are forced to the center of the rotor core 40 and, as such, leave a positive charge on the outer surface 82 of the rotor core 40. However, this repulsion of electrons from the outer surface 82 of the rotor core 40 causes a build-up of electrons on the inner perimeter 72 of the rotor core 40. Accordingly, the inner perimeter 72 of the rotor core 40 develops a negative charge.

Turning now to FIG. 3, the dielectric layer 46 disposed between the rotor core 40 and the rotor shaft 26 prevents the migration of electrons from the rotor core 40 to the rotor shaft 26. In other words, the dielectric layer 46 prevents the electrical communication of charge on the inner perimeter 72 of the rotor core 40 to the outer perimeter 70 of the rotor shaft 26, i.e., current. Accordingly, a build-up of charge on the rotor shaft 26 due to the electrostatic coupling between the stator core 30 and the rotor assembly 36 is reduced. Although the dielectric layer 46 may cause capacitive coupling between the rotor core 40 and the shaft 26, the shielding properties of the dielectric material 46 reduce the effect of the charge build-up on the rotor core 40 on the rotor shaft 26. For example, the build-up of electrons on the inner perimeter 72 of the rotor core 40 may repel free electrons located on the outer perimeter 70 of the rotor shaft 26 and, as such, leave a positive charge on the outer perimeter 70 of the rotor shaft 26. However, as mentioned above, the shielding properties of the dielectric material 46 reduce the effect of the electrical field produced by the build-up of charge on the rotor core 40. Accordingly, the dielectric layer 46 disposed between the rotor core 40 and the shaft 26 reduces the amount of charge build-up on the rotor shaft 26 or shaft charge (V_{rg}) due to electrostatic coupling.

As discussed above, the build-up of charge on the shaft 26 (i.e., shaft charge or V_{rg}) is electrically communicated to the inner race 56 of the respective bearing sets 50 and 52. However, by reducing the build-up of charge on the rotor shaft 26 and, as such, on the inner race 56 of the respective bearing sets, the charge or V_{rg} developed in the bearing sets is reduced. Thus, the likelihood of the voltage or V_{rg} in the bearing sets exceeding the electrical field threshold value of the lubricant 62 is reduced. That is, the V_{rg} or shaft charge in the bearing sets is not sufficient to overcome the dielectric properties of the lubricant 62. Accordingly, the likelihood of bearing currents (I_{b}) and EDM occurring is also reduced, thereby mitigating the likelihood of premature bearing failure.

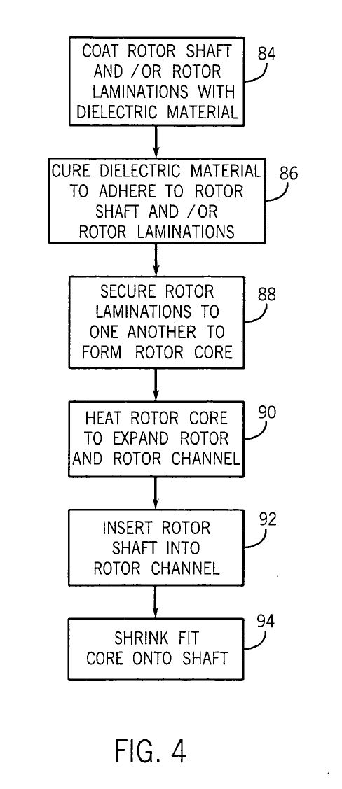

Keeping FIGS. 1-3 in mind, FIG. 4 illustrates an exemplary process for manufacturing an exemplary rotor assembly 36. The process includes coating a prefabricated rotor shaft 26 and/or a rotor core laminate 38 with a dielectric material 46. (Block 84.) Advantageously, to increase the adherence of the dielectric material to the rotor shaft 26 and/or the rotor lamination 38, the rotor shaft and/or lamination may be chemically cleaned prior to coating with the dielectric material 46. The exemplary process also includes curing the dielectric material to adhere the material to the rotor shaft 26 and/or the rotor laminations 38. (Block 86.) To form the rotor core 40, the exemplary process includes the act of securing and aligning the rotor laminations 38 together. (Block 88.) By way of example, the rotor core 40 may be secured with respect to the rotor end rings 42 with thru-bolts extending axially through the rotor core 40. To secure the rotor core 40 with respect to the rotor shaft 26, a “shrink-fit” process may be employed. The exemplary shrink-fit process comprises heating the rotor core 40 to expand the rotor core 40, thereby increasing the diameter of the rotor channel and/or freezing the rotor shaft 26, thereby decreasing the diameter of the shaft 26. (Block 90.) Once the rotor core 40 and its channel have been expanded, the rotor shaft 26 maybe inserted into the rotor channel. (Block 90.) By allowing the rotor core 40 to return to quiescent temperatures, the core 40 shrink-fits onto the shaft 26. (Block 94.) The tight fit between the rotor core 40 and the shaft 26 secures the two elements with respect to one another, thereby creating a contiguous rotor assembly 36 that acts as a unit.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A rotatable element, comprising:
a core having a generally circular cross-section and a channel extending along an axial centerline of the core from a first end of the core to a second end of the core generally opposite the first end, wherein the axial centerline is generally transverse to the circular cross-section;
a shaft secured with respect to the core and extending through the channel such that the shaft extends beyond at least one of the first and second ends of the core; and
a dielectric layer disposed between the shaft and the core such that the dielectric layer electrically insulates the core and shaft with respect to one another.

2. The rotatable element as recited in claim 1, wherein the dielectric layer comprises a ceramic material.

3. The rotatable element as recited in claim 2, wherein the dielectric layer comprises aluminum oxide.

4. The rotatable element as recited in claim 1, wherein the dielectric layer comprises a plastic material.

5. The rotatable element as recited in claim 1, wherein the core comprises a plurality of rotor laminations.

6. The rotatable element as recited in claim 1, wherein the dielectric layer is adhered to the shaft.

7. The rotatable element as recited in claim 1, wherein the dielectric layer is adhered to the core.

8. The rotatable element as recited in claim 1, wherein the dielectric layer comprises a high yield-strength material.

9. An electric motor system, comprising:
a frame;
a stator assembly housed in the frame, the stator assembly having a stator channel extending from a first stator end to a second stator end generally opposite the first stator end; and
a rotor assembly disposed in the stator channel, the rotor assembly comprising:
a core having a first rotor end and a second rotor end generally opposite the first rotor end;
a shaft extending axially through the core from the first rotor end to the second rotor end; and
a dielectric layer disposed between the core and shaft such that the dielectric layer electrically insulates the core and shaft with respect to one another.

10. The electric motor system as recited in claim 9, wherein the at least one of the stator assembly and the core comprises a plurality of laminations.

11. The electric motor system as recited in claim 9, wherein the dielectric layer comprises a ceramic material.

12. The electric motor system as recited in claim 11, wherein the ceramic material comprises aluminum oxide.

13. The electric motor system as recited in claim 9, wherein the dielectric layer is adhered to the shaft.

14. The electric motor system as recited in claim 9, wherein the dielectric layer is adhered to the core.

15. The electric motor system as recited in claim 9, wherein the stator includes stator windings configured to receive power from an alternating current (ac) power source.

16. The electric motor system as recited in claim 15, wherein the stator winding are configured to receive power from a pulse width modulated (PWM) inverter.

17. The electric motor system as recited in claim 15, comprising the ac power source.

18. An electric motor, comprising:
a stator core having a stator channel extending therethrough;
a rotor core having a generally circular cross-section disposed within the stator core;
a shaft extending at least partially through the rotor core along an axial centerline of the rotor core, wherein the axial centerline is generally transverse to the rotor core cross-section; and
an electrically insulative material located between the shaft and the rotor core such that the electrically insulative material decreases a charge in the shaft due to capacitive coupling between the rotor and the stator developed during operating of the motor.

19. The electric motor as recited in claim 18, wherein the electrically insulative material comprises a ceramic material.

20. The electric motor as recited in claim 19, wherein the ceramic material comprises aluminum oxide.

21. The electric motor as recited in claim 18, wherein the electrically insulative material is adhered to the shaft.

22. The electric motor as recited in claim 18, wherein the electrically insulative material is adhered to the rotor.

23. A method of manufacturing a rotor, comprising:
forming a rotor core having a generally circular cross-section and a channel extending through the rotor core axially along a centerline of the rotor core, wherein the centerline is generally transverse to the rotor core cross-section;
applying a dielectric material to at least one of an outer perimeter of a rotor shaft and an inner perimeter of the rotor core defined by the channel;
inserting the rotor shaft into that channel; and
securing the rotor shaft with respect to the rotor core.

24. The method as recited in claim 23, wherein securing comprises shrink-fitting the rotor core onto the rotor shaft.

25. The method as recited in claim 23, wherein forming comprises aligning and securing a plurality of rotor core laminations with respect to one another.

26. The method as recited in claim 23, wherein coating comprises adhering the dielectric material to at least one of the rotor shaft and the rotor core.

27. A method of reducing shaft charge in a rotor shaft during operation of a motor, comprising:
electrically insulating a rotor shaft extending through a channel of a rotor core from the rotor core with a dielectric material disposed between the outer perimeter of the rotor shaft and an inner perimeter of the rotor core defined by the channel to reduce shaft charge on the rotor shaft during operation of the motor.

28. An electric motor, comprising:
means for rotatably supporting a rotor having a rotor core and a rotor shaft extending through the rotor core within a stator core; and
means for electrically insulating the rotor shaft with respect to the rotor core.
